(19) United States
(12) Patent Application Publication
(10) Pub. No.: US 2003/0233216 A1
(43) Pub. Date: Dec. 18, 2003

(54) Tester information web service

(76) Inventor: Norman Ken Ouchi, San Jose, CA (US)

Correspondence Address: NORMAN KEN OUCHI, 20248 VIEWCREST CT., SAN JOSE, CA, 95120, US

(21) Appl. No.: 10/173,456

(22) Filed: Jun. 15, 2002

(51) Int. Cl. G06F 15/00

(52) U.S. Cl. 702/186

(57) ABSTRACT

This invention is related to the communication of information to support the validation and test operations in a distributed manufacturing or repair process.

In the present invention, a product is manufactured or repaired. To verify that the product is operating correctly, the product is tested using programmable test equipment. When a product is tested, the correct test program must be activated in the programmable test equipment. The present invention provides a centralized facility from which a product is related to a test program and from which, when the product is tested, the related test program is determined. The centralized facility is provided as an Internet Web service so the testers, which may be distributed over a wide geography, are easily connected to the central facility. As a Web service, the functions of a centralized facility are provided without the need for physical hardware or programs for the users of the facility except for a computer with a browser and Internet connection. The central facility also collects tester information related to testing the product and information about the tester. The information and statistics based on the information are generated and published on the Web service.

### CROSS-REFERENCE TO RELATED APPLICATIONS

None

### STATEMENT REGARDING FEDERALLY SPONSORED RESEARCH OR DEVELOPMENT

None

### FIELD OF THE INVENTION

This invention is related to the communication of information to support the validation and test operations in a distributed manufacturing or repair process.

### BRIEF SUMMARY OF THE INVENTION

In the present invention, a product is manufactured or repaired. To verify that the product is operating correctly, the product is tested using programmable test equipment. When a product is tested, the correct test program must be activated in the programmable test equipment. The present invention provides a centralized facility from which a product is related to a test program and from which, when the product is tested, the related test program is determined. The centralized facility is provided as an Internet Web service so the testers, which may be distributed over a wide geography, are easily connected to the central facility. As a Web service, the functions of a centralized facility are provided without the need for physical hardware or programs for the users of the facility except for a computer with a browser and Internet connection. The central facility also collects tester information related to testing the product and information about the tester. The information and statistics based on the information are generated and published on the Web service.

### BACKGROUND OF THE INVENTION

As a product is manufactured, there may be tests to validate that the product was manufactured correctly. For some products the equipment used to test a product is specifically designed to test that product or a limited variation of the product. For many products, there are programmable testers and the testers are used to test a wide variety of products. However, a test program must be developed to test a specific product and the test program must be associated with the product to be tested. In general, a change in the product will require a change in the test program. In the electronics industry, a product will evolve during its life cycle to keep the product competitive. The test program must evolve to not only account for the changes in the product but also to improve the capabilities of the test program to detect defects that were missed in earlier versions of the test program. The key point is the test program is directly related to the product to be tested. The product has an identifier, usually a part number and an engineering release level. The part number is a unique identifier assigned to a product and the engineering release level designates a specific base product design and set of changes made to the product. A minor change in the product creates a variant with the same part number and a unique engineering change level. The test program has a test identifier, usually a part number and an engineering release level. Note that the part numbers for the product and test program do not have to be the literally the same. As an example, a product with part number 1234 with engineering release level A3 is tested using the test program with part number TEST567 with engineering release level 345Q. When a product with part number 1234 with engineering release level A3 is tested with a tester using the test program TEST567 with engineering release level 345Q, the product should pass if manufactured correctly and fail if there is a manufacturing defect. However, if the product evolves to a variant with engineering release level, A4, the test program TEST567 with engineering release level 345Q may incorrectly indicate a failure because of the change in the product. Or, it may incorrectly miss a defect and pass a defective product because of the change in the product and the test program was not designed to reflect the change in the product. The product must be tested using the related test program.

In the past, the rate of change in the product was low enough that a manual process or a local database was adequate to relate the product to the test program. In most cases, the product was built and tested in one location. However, the rate of change for products is now very high and the product is built globally. In many instances the product is not built in the company that designed the product but in a contract manufacturer, a company that provides manufacturing and test services. The product may not be built in one contract manufacturer but in several and at globally distributed locations. Changes in the product and the test programs and changes in the manufacturing locations occur at a high rate of change and the manual processes or the automated processes that use local databases are no longer adequate. Many variants of a product may be manufactured concurrently. There are a variety of reasons for this. The product change may permit the continued manufacture of the previous engineering release level to consume components before building the new engineering release level. Or, an older product is repaired or upgraded. A means to relate the test program to the product to be tested must be provided.

When a new or modified test program is developed, the program must be related to the product identifier of the product for which the program was developed to test and also must be distributed to the tester so the test program is available to test the product. In the prior art, the test program was distributed using physical media such as diskettes or CD's or using the File Transfer Protocol (FTP) on the Internet. Physical media introduces a significant delay in the distribution. The use of physical media or FTP identifies the test program by a file name and does not easily relate the test program to the product to be tested. Careful file naming can minimize the exposure to errors but does not provide a secure means to assure that the test program was associated with the product to be tested. A means to distribute the test programs that maintains the test program identity would be desirable.

The test results are very important. The results are used to fix the problem for the specific unit that failed. But more importantly, the results provide statistical measurements of the manufacturing capabilities and the design of the product with respect to manufacturability. The results are not only the test results but also the decisions that are made that affect the product. For instance, a unit may be scrapped because the errors are so severe that it was no longer economically feasible to repair the unit. The results should be from the testers at the global locations as a product is manufactured and tested. The results should be real time so that a minimum of defective products are manufactured because of a defective product design, a defective test program, or a defective component that is used to manufacture the product. A means to store test results in a central facility is desirable. When a product unit fails, in many cases the unit is repaired and retested. There is value in tracking the unit in the repair process and collecting and displaying information related to the unit, the failure, and the repair as the unit is repaired and retested. Every manufacturing person has the “war stories” of units getting lost in repair, of units repaired many times exceeding their economic value, of units where the wrong part was “fixed” because the error symptoms were not with the unit. A means to track a unit in the repair process and collecting and displaying the information related to the unit could be provided. The means to determine the correct test program to test a product must have a minimum impact and delay since the location to manufacture a product can change quickly. A delay in establishing a means to get the correct program is a delay in testing the product and thus, a delay in the delivery of the product.

A product is developed by a company and manufactured by contract manufacturers. The contract manufacturers have programmable test equipment that requires a program developed to test the product. The contract manufacturers are global and the product is manufactured at multiple locations. The locations change based on economy and the stage of the product in its product life cycle. The test program is related to the product and changes as the design of the product changes and changes to improve the test process. A contract test program development company develops the test program. There are multiple variants of the product in production. The rates of change are high for the product, for the test programs, and for the manufacturing locations. The product development company needs to assure that the correct test program is used to test the product. The product development company, the test development company and the contract manufacturers need to see the test results to control the manufacture of the product. Each needs a different view of the results in real time. The development company and the test program development company must control and distribute the test programs to the sites of the contract manufacturers. The solution to these issues must accommodate the high rates of change and have a low cost and ease of implementation.

### BRIEF DESCRIPTION OF DRAWINGS

None

### DESCRIPTION OF THE INVENTION

In the present invention, the Tester Information Web Service is connected to the Internet and cross-references a product identifier to a test program identifier of a test program to be used to test a unit of the product with the product identifier. A tester is connected to the Internet. When a product unit is tested, the product identifier (usually the part number and engineering release level) is used by the tester to query, using the Internet, the Tester Information Web Service. The response is the test program identifier (usually the part number and engineering release level of the test program). The tester uses the test program as specified by the test program identifier to test the product unit and has a level of assurance that the correct test program was used. The cross-reference in the Tester Information Web Service is modified using a computer with a Web browser connected to the Internet. This permits the test engineers to manage the relationship of product to test program in a central facility. Using the Tester Information Web Service, an engineer stores a test program, relates the test program to a product, releases the test program for use, and has assurance that the correct test program will be used to test the product. New test programs or changes to test programs are propagated quickly to testers on a global basis. As a central facility, the Tester Information Web Service provides the information so that all of the associated testers form a global network. The Internet permits ease of connection and rapid adoption of use.

The Tester Information Web Service is used to collect the test results and decisions from all of the testers that test a specific product. With this, the test result information is centralized and permits real time status and statistics of tests on the product. The view of the information is tailored to meet the requirements of the recipient. For example, the company that developed the product sees all of the information while a contract manufacturer can only see the details of units they manufactured and cannot see the details of units manufactured by competing contract manufacturers. The failure symptoms, comparison between facilities, the throughput, etc. are reported in real time. The Internet and computers with browsers are used to access the reports.

The test system can be integrated into a network of testers even if the tester is not adapted to access the Internet. The Tester Information Web Service can be accessed with a computer with a web browser by entering the product identifier into a Web page. The Tester Information Web Service replies with the identifier of the test program. If the test program is not in the tester, the correct test program is downloaded from the Tester Information Web Service using a Web page on the computer and the connection to the Internet. The test program is then transferred from the computer to the tester.

A repair location can be made a member of the network. When a unit fails the test and the unit is assigned to a repair location, the repair location accesses the Tester Information Web Service using a PC with a browser and views the test results associated with the unit. As repairs are made, the repair information and additional information are entered and associated with the unit. When the unit is repaired and returned to the tester, the tester accesses the Tester Information Web Service. The tester then retests the unit. If the unit fails again, all of the history for the unit is available in the Tester Information Web Service. The unit is tracked in the repair process and the information associated with the unit is collected and displayed.

As a Web service, the Tester Information Web Service supports multiple, independent global networks of testers by dividing the cross-reference into segments where the testers and users in a network have access to a segment associated with the network. Each network is virtual in that the network does not require hardware or software other than connections to the Internet and the network members are defined by the access permission grated to a tester or user to access the specific subset of the cross-reference information associated with the network. If granted permission to access the Tester Information Web Service segment dedicated to a network, the tester or user becomes a member of that network. A network grows or collapses by adding or removing user access permissions. A tester can be a member of multiple networks with access permissions to the segment associated with each network for which it is a member.

The Tester Information Web Service can derive income based on the usage of the service. The number of access permissions, the number of cross-reference accesses, the number of test results, the number of test program downloads, etc. are potential measurements of usage. A second source of revenue is advertising specific to the test program development community. The engineers of the tester networks will be using the Tester Information Web Service and shared forums and other elements of common interest can be developed so that the engineers will find additional value so a community of interest can develop. The community of interest can gain value from appropriate advertising and become a source of advertising revenue.

The application of the Tester Information Web Service is not limited to testers of electronic products but extends to testing where the testers are programmable and the program in the tester must be related to the article to be tested. The tester program is not limited to the programs to identify that a defect is in a unit but extends to the programs used to identify the defect or cause of the defect. These programs may be called diagnostic programs. The application of the Tester Information Web Service is not limited to the initial identification of the test program related to the product and extends to the identification of other test programs related to the product that may be invoked by the initial test program. The Tester Information Web Service is not limited to testing but extends to manufacturing or assembly of products where the manufacturing or assembly equipment is programmable and the program in the manufacturing or assembly equipment must be related to the article to be manufactured or assembled.

Description of a Preferred Embodiment

The Tester Information Web Service is implemented as software programs written in Java, C++, Microsoft Visual Basic, or a number of programming languages. The programs may use a database for storing the product identifier and cross-reference to the test program identifier. Database programs are available from Oracle, IBM, Microsoft, and many other providers. The Web server is a program that creates the web pages and provides functions secure Internet information transmission to support the Tester Information Web Service interface to the Internet. Web server programs are available from Microsoft, Netscape, and other providers. These programs and databases execute in computers manufactured by, for example, IBM, Sun, Dell, and Compaq. The computers may be, for example, PC's, workstations, mainframes, and hand-held computers. The computers may have an operating system such as UNIX, LINUX, Microsoft 2000, and IBM OS/9000. The computer is connected to the Internet that may be, for example: Internet, Intranet, extranet, wireless LAN that connects to the Internet, or wireless Internet. These technologies are evolving very rapidly and the embodiment is not limited to those examples cited. The Tester Information Web Service is a set of programs that uses a Web server to provide the interface to the Internet, a relational database to store the control and smaller data information, and a file management system to store larger data information like the test programs as files.

The Tester Information Web Service programs use a relational database for storing the information for the cross-reference, the tester and user access, and other information. The test programs are stored in a file management system. The cross-reference information is stored in a relational database is stored in a table where a first column is the product identifier and a second column is the test program identifier. A product identifier to test program identifier association is formed by storing the product identifier in the first column of a row and the test program identifier is stored in the second column of the row. When the Tester Information Web Service program is given a request with a product identifier, the Tester Information Web Service program accesses the relational database with the product identifier in the relational database query and the database returns with the test identifier. There may be zero, one, or more than one test identifier in the reply from the database in the response to the query. The Tester Information Web Service program must accommodate these responses from the database. The relationship between a product identifier and a test program identifier is changed or deleted by appropriate changes to the row in the database. The Tester Information Web Service is segmented by network by a column in the relational database tables. A row in the database associated with a network has the network identifier in the network column. The use of this column and the network identifiers segments the database when the network identifier is one of the arguments in the database queries. The tester and user access permissions are stored in the relational database with the network column so the tester and users are segmented by network. The database is used to store the test results and information associated with a product. The information in the database is associated with the product identifier as well as the network identifier so the information is stored and retrieved correctly. The information is extracted from the database so that each user sees the information that the user needs to see and does not see information that the user should not see.

The reported location of a unit of a product is kept in a relational database table. If a unit of a product fails this table is updated to designate the last reported location of the unit. When the unit is moved, the receiving location updates this table so the location is current. The table also identifies the next expected location to where the unit is to be moved. Those skilled in the art recognize this function as one used in shopfloor control and tracking systems where this application of this function applies to tester, users, and repair locations, etc. that are connected to the Tester Information Web Service through the Internet rather than the usual LAN connection of a shopfloor control and tracking system. The tester program identifier and the file management identifier is stored in a relational database table so that when a tester program is stored as a file in the file management system, a row in the table relates the tester program identifier with the file identifier in the file management system. When a tester program is requested using the tester program identifier, the row in the database is located using the tester program identifier and the file identifier is returned. The file identifier is used to get the file that is test program and is used to fulfill the request.

Those skilled in the art realize that the functions ascribed to the Tester Information Web Service may be implemented in many technologies and different programs. The programming languages provide large building blocks from which to construct the Tester Information Web Service functions and the program design will depend on the selection of the building blocks.

I claim:

1. A Tester Information Web Service and a programmable tester, both connected to the Internet, wherein the Tester Information Web Service provides a product identifier and a related test identifier and the tester queries the Tester Information Web Service with the product identifier and the Tester Information Web Service returns the related test identifier to the tester.

2. The Tester Information Web Service of claim 1 wherein the tester uses the test identifier to select the test program to test a product unit with the product identifier.

3. The Tester Information Web Service of claim 1 wherein Tester Information Web Service further stores the result of a test and the tester sends the result of a test of a product unit to store in the Tester Information Web Service.

4. The Tester Information Web Service of claim 1 wherein Tester Information Web Service further stores the result of a test and a report of the test result is generated.

5. The Tester Information Web Service of claim 1 wherein the Tester Information Web Service further stores and distributes test programs and a test program with a test program identifier is created or modified, stored and distributed by the Tester Information Web Service, and the created or modified test program used by the tester when testing a product unit with the product identifier.

6. The Tester Information Web Service of claim 1 wherein the Tester Information Web Service further stores and distributes test programs and a test program with a test identifier is modified at the tester and the modified test program is stored and distributed by the Tester Information Web Service.

7. The Tester Information Web Service of claim 1 and a repair location connected to the Internet wherein Tester Information Web Service further stores information related to a product unit and the repair location sends information related to the product unit at the repair location to store in the Tester Information Web Service.

8. The Tester Information Web Service of claim 1 wherein Tester Information Web Service further stores information related to a product and a report with the information is generated.

9. A Tester Information Web Service and a computer with a Web browser both connected to the Internet wherein the Tester Information Web Service provides a product identifier and a related test identifier and the product identifier of the product to be tested is entered in a Web page on the computer to query the Tester Information Web Service and the Tester Information Web Service returns the related test identifier to the computer in a Web page.

10. The Tester Information Web Service of claim 9 and a programmable tester, wherein the tester uses the test identifier to select a test program to test a product unit with the product identifier.

11. The Tester Information Web Service of claim 9 wherein the Tester Information Web Service further stores the result of a test and the result of a test of a product unit is entered in a Web page on the computer and sent to be stored in the Tester Information Web Service.

12. The Tester Information Web Service of claim 9 wherein Tester Information Web Service further stores the result of a test and a report of the test result is generated.

13. The Tester Information Web Service of claim 9 wherein the Tester Information Web Service further stores and distributes a test program and a test program with a test identifier is created or modified, stored and distributed by the Tester Information Web Service and the created or modified test program used by the tester when testing a product unit with the product identifier.

14. The Tester Information Web Service of claim 9 wherein the Tester Information Web Service further stores and distributes a test program and a test program with a test identifier is modified at the tester and the modified test program is entered in a Web page on the computer and stored and distributed by the Tester Information Web Service.

15. The Tester Information Web Service of claim 9 wherein Tester Information Web Service further stores information for a product and the information for a product unit is entered in a Web page on the computer and the information is stored in the Tester Information Web Service and a report based on the information is generated.

16. The Tester Information Web Service of claim 9 and a repair location having a computer with a Web browser connected to the Internet, wherein Tester Information Web Service further stores information related to a product and the repair location enters information related to a unit of a product at the repair location in a Web page on the computer to store in the Tester Information Web Service.

17. A Tester Information Web Service billing calculation wherein the use of the Tester Information Web Service is measured and usage of the service is part of the calculation to determine the price of the use of the service.

18. The Tester Information Web Service billing calculation of claim 17 wherein the Tester Information Web Service provides a means for advertising and the usage of the service is part of the calculation to determine the price of the advertising service.
